(19) United States
(12) Patent Application Publication
(10) Pub. No.: US 2002/0156670 A1
(43) Pub. Date: Oct. 24, 2002

(54) Method of managing workers at a well site

(76) Inventor: Frederic M. Newman, Midland, TX (US)

Correspondence Address: ROBERT J. HARTER, 4233 CLIFFSIDE DRIVE, LA CROSSE, WI, 54601, US

(21) Appl. No.: 09/839,411

(22) Filed: Apr. 23, 2001

(51) Int. Cl. G06F 17/60

(52) U.S. Cl. 705/9

(57) ABSTRACT

A method that enables an owner or an operator of a well to manage workers that are performing various service operations at a remote well site. The method involves a wireless communication link that allows one computer at a home base location to communicate with a mobile computer associated with a service vehicle at the well site. Workers of several independent contractors enter employee data into the same mobile computer to indicate who is at the well site. Transducers associated with various service operations feed electrical signals into the computer along with a time stamp, which helps confirm that a worker is actually working at the well site. An owner or operator of the well can then access the information using the home base computer and the wireless communication link to help determine who is working at well site, what they are doing, and when they are doing it.

### BACKGROUND OF THE INVENTION

1. Field of the Invention

The invention generally pertains to managing workers at a well site and more specifically to managing workers associated with multiple service vehicles of various contractors.

2. Description of Related Art

After a well is set up and operating to draw petroleum, water or other fluid up from within the ground, various service operations are periodically performed to maintain the well. Such service operations may include replacing worn parts such as a pump, sucker rods, inner tubing, and packer glands; pumping chemical treatments or hot oil down into the well bore; and pumping cement into the well bore to partially close off a portion of the well (or to shut it down entirely). Since wells are often miles apart from each other, the maintenance or service operations are usually performed by a mobile unit or service vehicle having special onboard servicing equipment suited to perform the work. Some examples of service vehicles include a chemical tank truck or trailer, a cement truck or trailer, a hot-oiler tank truck or trailer, and a portable work-over service rig having a hoist to remove and install well components (e.g., sucker rods, tubing, etc.).

Service vehicles are often owned by a contractor that an oil company, such as a well owner or operator, hires to service the wells. Typically, the contractor invoices the oil company after supposedly performing the work at a remote well site. However, since the work is usually done at a remote location relative to the oil company's home office, the oil company may find it difficult to confirm precisely what occurred at the well site, especially after the fact.

For example, the oil company may not know which individuals did the work, whether they were qualified to do it, how long it took them, or how well the job was performed. A conventional time clock that records the arrival and departure of a factory or office employee does not distinguish between those who actually work and those that do not. For some service operations, such as pumping cement or acid into the well bore, it may difficult to confirm to what extent the operation was performed or whether the operation was even done at all. Consequently, in paying for services, oil companies may pay more than what the contractor was actually entitled.

### SUMMARY OF THE INVENTION

To avoid the problems and limitations of existing worker management systems, it is an object of the invention to use a wireless communication link to allow a well owner or an operator at a home base to manage workers that have been assigned to perform various service operations at a remote well site.

A second object of the invention to have one computer on one service vehicle collect data from multiple independent contractors each associated with their own employees and service vehicle, wherein the data pertains to employee information and a process performed with the assistance of the service vehicles.

A third object of the invention is to enable a well owner or an operator of a well to compare the time when a worker is present at the well site and the time when a service vehicle is assisting in performing a service operation.

A fourth object is to have a computer receive input from a transducer associated with a service operation and receive input pertaining to employee information.

A fifth object is to use a computer to authorize a worker to perform a service operation at a well site.

A sixth object is to use a common computer to collect data from independent contractors performing separate service operations, such as pumping and manipulating tubing or sucker rods, downhole logging and manipulating tubing or sucker rods, and pumping and downhole logging.

These and other objects of the invention are provided by a worker management method that enables an owner or an operator of a well to manage workers that have been assigned to perform various service operations at a remote well site. The method involves using a wireless communication link that allows one computer at a home base location to communicate with a mobile computer associated with a service vehicle at the well site. Workers of one or more independent contractors enter information into the mobile computer to indicate who is at the well site and what equipment is actually operating. An owner or operator of the well can then access the information using the home base computer.

### BRIEF DESCRIPTION OF THE DRAWINGS

FIG. 1 is a schematic view of a method for a company at a home base to monitor worker activity at a remote well site.

### DESCRIPTION OF THE PREFERRED EMBODIMENT

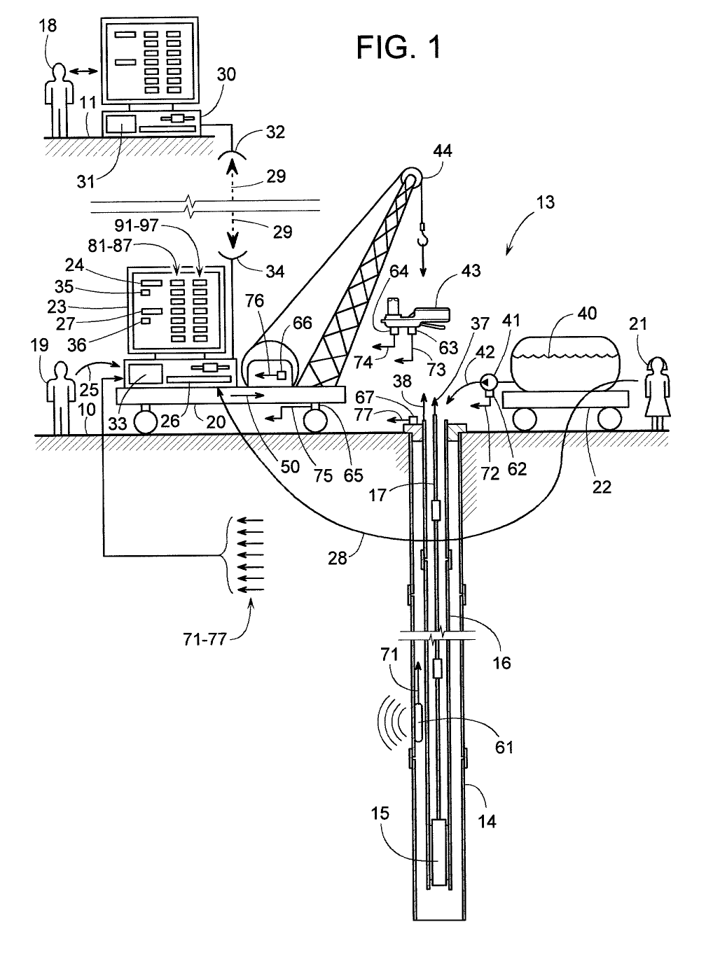

Worker activity at a well site 10 can be monitored from a remote location 11 by using a method 12 illustrated in FIG. 1. Here, a well 13 is schematically illustrated to encompass any apparatus for drawing a fluid (e.g., oil, gas, water, etc.) from the ground. In some embodiments of the invention, well 13 includes a string of outer piping known as casing 14. When perforated, casing 14 provides a conduit that conveys fluid from within the ground to the inlet of a submerged reciprocating pump 15. An inner string of pipe, known as tubing 16, provides a discharge conduit that conveys the fluid from the outlet of pump 15 to the surface. A powered pivoting beam (not shown) moves a string of sucker rods 17 up and down, which in turn moves the pump's piston up and down to pump the fluid.

Owners, operators, and/or well managers (all of which are referred to herein and below as company 18) of well 13 may pay various contractors, which have their own workers and service vehicles for performing different service operations on well 13. For example, one contractor may have a worker 19 and a service vehicle 20, and another contractor may have a worker 21 and a service vehicle 22. Method 12 is especially useful in coordinating the efforts of independent contractors, such as when workers 19 and 21 are not employees of company 18, and/or when workers 19 and 21 are employed by different contractors.

When worker 19 arrives at well site 13, he enters into a computer 23 employee data 24 that notifies company 18 of his arrival. The term, “computer” used herein and below refers to any device for storing and/or possessing digital information. Examples of a computer include, but are not limited to items known as personal computers, PC, desktop computer, laptop, notebook, PLC (programmable logic controller), data logger, etc. It should be appreciated by those skilled in the art that a computer may be associated with appropriate common software (e.g., Microsoft Word, Excel, Access; Visual Basic; C++ etc.) and various internal or external circuitry, such as I/O boards and A/D converters. Data 24 can be entered (indicated by line 25) by using a computer keyboard 26, a bar code scanner, or by using any other conventional input device. The term, “employee data” refers to any information that helps identify a worker. Examples of employee data include, but are not limited to, a worker's name or initials, a worker identification number (e.g., employee serial number, social security number or part thereof), a worker's driver's license number, a worker's job title, etc. Likewise, worker 21 enters her employee data 27 into computer 23 in a similar manner, as indicated by line 28. Even though workers 19 and 21 may be employed by different contractors, both workers 19 and 21 preferably use the same computer 23, which vehicle 20 of one of the contractors transports (indicated by arrow 50) to and from well site 13.

To notify company 18 of the arrival of workers 19 and 21, and thus notify the arrival of their respective vehicles 20 and 22 at well site 10, a wireless communication link 29 places computer 23 in communication with another computer 30 at a remote location, such as at a home base office of company 18. The term, “remote location” means that the location of computer 30 is beyond the immediate property or land on which well 13 is contained or at least one-mile away from well 13, whichever is greater. The term “wireless communication link” refers to data being transmitted over a certain distance, wherein over that certain distance the data is transmitted through a medium of air and/or space rather than wires. Wireless communication link 29 is schematically illustrated to represent a wide variety of systems that are well known to those skilled in the art of wireless communication. For example, with a modem 31 and an antenna 32 associated with computer 30, and another modem 33 and an antenna 34 for computer 23, employee data 24 and 27 can be exchanged over the Internet between computers 23 and 30. Thus, employee data 24 and 27 can be displayed on both computers 23 and 30 using any of a variety of common formats including, but not limited to HTML, e-mail, etc.

In some versions of the invention, company 18 expresses their approval of workers 19 and 21 by communicating authorizations 35 and 36 from computer 30 to computer 23. Approval authorization may be based on employee's training, safety record, experience or other qualifications to do a particular service operation. Once approved, workers 19 and 21 may proceed to work on well 13.

Any work done to well 13 is referred to as a service operation. Examples of service operations include, but are not limited to manipulating sucker rods (e.g., installing, torquing, or replacing rods 17, as indicated by arrow 37); manipulating tubing (e.g., installing, torquing, or replacing tubing 16, as indicated by arrow 38); down hole logging, as indicated by a transducer 71 suspended from a wireline; pumping a fluid 40 (e.g., cement, acid, hot oil, etc.) into well 13, as indicated by a pump 41 and arrow 42; perforating; welding; fracture treatments; drilling; stimulating; swabbing; bailing; testing; and various other work that is familiar to those skilled in the art.

To perform various service operations, workers 19 and 21 preferably use specially designed or equipped service vehicles. The term, “service vehicle” refers to any vehicle used to facilitate initiating, performing, or completing one or more service operations on well 13. Examples of a service vehicle include, but are not limited to, mobile work-over unit 20 and a tanker 22. Work-over unit 20 may include a variety of equipment including, but not limited to, tongs 43 (e.g., rod tongs or tubing tongs), and a wireline winch and/or a hoist 44. Work-over unit 20 is particularly suited for removing or installing well components, such as sucker rods 17, tubing 16, etc.; lowering instruments, such as transducer 61, into the well bore via a cable or wireline; and may even be used in actually drilling the well bore itself Tanker 22 is schematically illustrated to encompass all other types of service vehicles including, but not limited to, pumping vehicles, such as a chemical tank truck or trailer, a cement truck or trailer, and a hot-oiler tank truck or trailer.

While performing a service operation, one or more transducers may be used in monitoring the various operations. For example, when pumping fluid 40 (e.g., hot oil, chemical, acid, gas, water, steam, cement, etc.) a transducer 62 can monitor things such as the fluid's volume or mass flow rate, pressure, temperature, acidity, or concentration. In some service operations, such as the removal and replacement of sucker rods 17, packer glands, tubing 16, etc., a transducer 67 (e.g., a proximity switch) could determine whether parts are being removed or installed. When replacing sucker rods 17 or other well components, a transducer 65 could monitor the load on hoist 44 by sensing the force or weight being carried by vehicle 20. Transducer 65 in conjunction with a transducer 66 for monitoring a hoist engine speed could monitor the force and horsepower required to pull rods 17 or tubing 16 from the well bore. For tongs 43, which are powered by a hydraulic system on vehicle 20, transducer 64 can be used to monitor or control the tong's hydraulic pressure or torque. Another transducer 63 can be used to monitor or control the tong's rotational speed. Transducer 61 can indicate the density of the ground surrounding casing 14 or can indicate the integrity or wall thickness of casing 14. The term, “transducer” refers to any device that provides an electrical signal in response to sensing a condition or status of a service operation. Examples of a transducer include, but are not limited to, a pressure switch, a strain gage, a temperature sensor, a flow meter, a tachometer, a limit switch, a proximity switch, etc. For the embodiment of FIG. 1, transducers 61, 62, 63, 64, 65, 66 and 67 respectively provide electrical signals 71, 72, 73, 74, 75, 76 and 77.

In some embodiments of the invention, the electrical feedback signals from one or more transducers are inputted (line 45) into computer 23 to serve as confirmation that workers 19 and 21 are actually performing service operations. Computer 23 can convert signals 71-77 to corresponding digital values 81-87. Values 81-87 can be stored and displayed alongside a corresponding number of time stamps 91-97 on computer 23. Each time stamp can be provided by an internal clock of computer 23, and would indicate the time of day that a particular transducer signal was taking readings or feeding signals to computer 23. Values 81-87 and their corresponding time stamps 91-97 can then be communicated through wireless communication link 29 to computer 30. This provides company 18 with an indication of who is working at well site 10, what they are doing, and when they are doing it.

Although the invention is described with reference to a preferred embodiment, it should be appreciated by those skilled in the art that various modifications are well within the scope of the invention. Therefore, the scope of the invention is to be determined by reference to the claims that follow.

I claim:

1. A method for a company to manage a first worker and a second worker at a well site, wherein the first worker is associated with a first service vehicle adapted to facilitate performing a first service operation at the well site, and the second worker is associated with a second service vehicle adapted to facilitate performing a second service operation at the well site, comprising:
transporting a first computer to the well site using the first service vehicle;
placing a second computer at a remote location relative to the well site, wherein the second computer is at least one mile away from the well site;
providing a wireless communication link between the first computer and the second computer;
entering into the first computer first employee data that suggests that the first worker associated with the first service vehicle is at the well site;
entering into the first computer second employee data that suggests the second worker associated with the second service vehicle is at the well site; and
communicating through the wireless communication link from the first computer to the second computer the first employee data and the second employee data, whereby the company at the second computer is made aware that the first worker, the first service vehicle, the second worker and the second service vehicle are at the well site.

2. The method of claim 1, further comprising:
using a transducer at the well site in a process related to the first service operation;
creating a first electrical signal from the transducer operating at the well site;
converting the first electrical signal to a first digital value;
storing the first digital value on the first computer; and
assigning a time stamp to the first digital value, thereby identifying at what time of day the transducer was operating at the well site, whereby the first employee data, the first digital value, and the time stamp suggest that the first worker was actually working at the well site.

3. The method of claim 1, further comprising displaying on the first computer authorization that suggests that the company approves of the first worker working on the first service operation at the well site.

4. The method of claim 1, wherein the first service operation involves pumping a fluid.

5. The method of claim 1, wherein the first service operation involves manipulating at least one of a plurality of sucker rods and a plurality of tubing.

6. The method of claim 1, wherein the first service operation involves downhole logging.

7. The method of claim 1, wherein the second service operation involves pumping a fluid, and the first service operation involves manipulating at least one of a plurality of sucker rods and a plurality of tubing.

8. The method of claim 1, wherein the second service operation involves downhole logging, and the first service operation involves manipulating at least one of a plurality of sucker rods and a plurality of tubing.

9. The method of claim 1, further comprising entering into the first computer a well site identifier that indicates the well site that the first worker is at.

10. A method for a company to manage workers intended for doing a service operation at a well site, comprising:
transporting a first computer to the well site;
entering into the first computer employee data that suggests a first worker is at the well site,
using a transducer at the well site, wherein the transducer is operating in a process related to the service operation;
creating a first electrical signal from the transducer operating at the well site;
converting the first electrical signal to a first digital value;
storing the first digital value on the first computer; and
assigning a time stamp to the first digital value, thereby identifying at what time of day the transducer was operating at the well site, whereby the employee data, the first digital value, and the time stamp suggests that the first worker was actually working at the well site.

11. The method of claim 10, further comprising displaying on the first computer authorization that suggests that the company approves of the first worker working on the service operation at the well site.

12. The method of claim 10, further comprising placing a second computer at a remote location relative to the well site; providing a wireless communication link between the first computer and the second computer; and communicating the employee data through the wireless communication link from the first computer to the second computer, whereby the company at the second computer is made aware that the first worker is at the well site.

13. The method of claim 10, wherein the service operation involves pumping a fluid.

14. The method of claim 10, wherein the service operation involves manipulating at least one of a plurality of sucker rods and a plurality of tubing.

15. A method for a company to manage a first worker and a second worker at a well site, wherein the first worker is associated with a first service vehicle adapted to facilitate performing a first service operation at the well site, and the second worker is associated with a second service vehicle adapted to facilitate performing a second service operation at the well site, comprising:
transporting a first computer to the well site;
entering into the first computer first employee data that suggests that the first worker associated with the first service vehicle is at the well site;
entering into the first computer second employee data that suggests the second worker associated with the second service vehicle is at the well site; whereby the first employee data and the second employee data suggest that both the first service vehicle and the second service vehicle are at the well site;
using a first transducer at the well site in a process related to the first service operation;
creating a first electrical signal from the first transducer operating at the well site;
converting the first electrical signal to a first digital value;
storing the first digital value on the first computer;
assigning a first time stamp to the first digital value, thereby identifying at what time of day the first transducer was operating at the well site, whereby the first employee data, the first digital value, and the first time stamp suggest that the first worker was actually working at the well site;
using a second transducer at the well site in a process related to the second service operation;
creating a second electrical signal from the second transducer operating at the well site;
converting the second electrical signal to a second digital value;
storing the second digital value on the second computer;
assigning a second time stamp to the second digital value, thereby identifying at what time of day the second transducer was operating at the well site, whereby the second employee data, the second digital value, and the second time stamp suggest that the second worker was actually working at the well site;
placing a second computer at a remote location relative to the well site;
providing a wireless communication link between the first computer and the second computer;
communicating the first employee data through the wireless communication link from the first computer to the second computer, whereby the company at the second computer is made aware that the first worker is at the well site; and
communicating the second employee data through the wireless communication link from the first computer to the second computer, whereby the company at the second computer is made aware that the second worker is at the well site.

16. The method of claim 15, further comprising displaying on the first computer authorization that suggests that the company approves of the first worker working on the first service operation at the well site.

17. The method of claim 15, wherein the second service operation involves pumping a fluid.

18. The method of claim 15, wherein the first service operation involves manipulating at least one of a plurality of sucker rods and a plurality of tubing.

19. The method of claim 15, wherein the second service operation involves downhole logging.
